(19) United States
(12) Patent Application Publication
(10) Pub. No.: US 2020/0153649 A1
(43) Pub. Date: May 14, 2020

(54) System and Method for Coordinating Personnel Response to Alarm Events in a Mobile Computing Environment

(71) Applicant: WIN-911 Software, Austin, TX (US)

(72) Inventors: Cody Bann, Round Rock, TX (US); Shushil Shahukhal, Houston, TX (US); Steven Rivas, Austin, TX (US); Christopher Rivas, Austin, TX (US)

(73) Assignee: WI-911 Software, Austin, TX (US)

(21) Appl. No.: 16/680,734

(22) Filed: Nov. 12, 2019

Related U.S. Application Data
(60) Provisional application No. 62/760,427, filed on Nov. 13, 2018.

(51) Int. Cl. H04L 12/18; H04W 4/12; H04L 29/08

(52) U.S. Cl. CPC H04L 12/1895; H04L 12/1831; H04L 12/189; H04L 12/185; H04L 67/26; H04L 67/18; H04L 67/24; H04L 67/10; H04W 4/12

(57) ABSTRACT

A system and method for pushing alarm condition notifications to team members responsible for responding to alarm events and for coordinating the responses of the team members by facilitating chat messages between such team members about that alarm condition. The system comprises server and mobile software applications that convey alarm event information and responses between an alarm event server and mobile devices of team members. The applications allow the team members to communicate and observe the status and responses for the entire team.

### CROSS REFERENCE TO RELATED APPLICATIONS

This application claims the benefit of U.S. Application No. 62/760,427, filed Nov. 13, 2018, the disclosure of which is incorporated by reference herein.

### BACKGROUND

Automated machinery is used in a variety of industries, such as manufacturing, water treatment, energy production and distribution, and other settings. The chief advantage of automated machinery is that the amount of required oversight, labor, and expertise is reduced, as compared with machinery that is not automated. Automated machineries are typically controlled by low-level standalone processors (such as PLCs) running operating systems like Ladder Logic, which open and close circuits to manipulate machinery. Labor requirements are further reduced when the low level standalone processors are integrated into a high-level network which synergistically gathers and distributes data from all automated machinery via a software platform capable of large scale control. Such a platform can conduct tasks like archiving historical trends, monitoring operating conditions, and evaluate alarm events. Monitoring programs and related hardware control devices integrated with the automated machinery are often referred to in the industry as Supervisory Control and Data Acquisition (SCADA) systems.

The SCADA industry developed the concept of alarm events that are designed to monitor operating conditions and alert the appropriate responders to “out-of-tolerance” conditions so that corrective action may be taken. These alarm events initially comprised data values like “On” or “Off” or a numeric limit that a value was not to exceed limit. When a responder is alerted to an alarm event, he or she would acknowledge the alarm, marking it as a condition whose responsibility for resolution has been accepted by the responder. Over the years the alarm event concept has been significantly enhanced to include a vast range of attributes like priority, elapsed time, severity, etc., resulting in an unlimited range of ways to process such events.

Situations arise where appropriate responders to alarm events are unavailable or not easily located, especially in plants that are not manned on a 24-hour basis, or the appropriate responders to handle the particular alarm event are not notified. In such cases, a plant may have to cease production unless there is a mechanism in place capable of alerting appropriate key personnel about operationally critical issues that require a response. This has led to the development of a class of products whose sole purpose is to notify appropriate personnel regardless of their physical proximity to an alarm event. It is critical for the notification product to “find” the appropriate person to respond to the particular alarm event wherever he or she is located, to have a backup notification plan in case that person is not available to respond, and to provide essential requisite data necessary to enable the alarm event to be resolved. Such alarm products comprise software referred to as remote alarm notification software.

Known remote alarm notification software products are generally designed to notify specified personnel in a sequential fashion (i.e., if a particular person A does not respond to the alarm, notify person B, etc.), or according to a more complex escalation process. While notification may be apparent to an individual end user (responder), the progress of that escalation of notifications with respect to other users (responders) may not be apparent to them individually. Moreover, communication between such responders can be hampered by inconsistent views and information about an alarm event, and unrelated coincident events which share superficial commonalities with the alarm event.

A system and method are needed for coordinating the notification and status of various team member responders who are sent information about the same underlying alarm condition of a monitored system, and for facilitating communications and coordination between such team members about that alarm condition. It is to these ends that the invention is directed.

### BRIEF DESCRIPTION OF THE DRAWINGS

FIG. 1 is a diagrammatic view of an alarm event notification system in accordance with the invention;

FIG. 2 is a diagrammatic view illustrating an overview of the operation and functioning of the alarm event notification system of FIG. 1;

FIG. 3 is a diagrammatic view of an Alarm Events display of a mobile device application in accordance with the invention;

FIG. 4 is a diagrammatic view of an Alarm Team display of a mobile device application in accordance with the invention as viewed by User 2;

FIG. 5 is a diagrammatic view of the Alarm Team display of FIG. 4 as viewed by User 3;

FIG. 6 is a diagrammatic view of an Alarm Chat display of a mobile device application in accordance with the invention as viewed by User 3;

FIG. 7 is a diagrammatic view illustrating the use of a share operation afforded by the invention in which a user forwards an alarm event via alternative collaboration tools (email) to another responder who appears to have not accessed his notification;

FIG. 8 is a diagrammatic view of the Alarm Team display similar to FIGS. 4 and 5 showing User 1's notification bar amplified with additional text information;

FIG. 9 is a diagrammatic view of an Alarm Events display that mirrors FIG. 3 but contains additional information.

FIG. 10 is a diagrammatic view of an Alarm Chat display that illustrates dialog coordination between Team Members;

FIG. 11 is a diagrammatic view of a Home Screen of a mobile device application in accordance with the invention;

FIG. 12 is a diagrammatic view that illustrates an expanded notification screen of a mobile device application in accordance with the invention;

FIG. 13 is a diagrammatic view that of an Alarm Team display screen that illustrates a “focusing” action;

FIG. 14 is a diagrammatic view of the screen display of FIG. 13 showing focusing by another Team Member;

FIG. 15 is another diagrammatic view similar to the screen display of FIG. 13 showing additional focusing and amplified information;

FIG. 16 is another view similar to the display screens of FIGS. 13 and 15 showing further information being presented;

FIG. 17 is a diagrammatic view of a Settings workspace display that enables a User to set the formatting for displaying different alarm items and notifications, including a Do Not Disturb option;

FIGS. 18 and 19 are diagrammatic views of displays of display screens for setting a date and time for a Do Not Disturb option;

FIG. 20 is a diagrammatic view similar to FIG. 17 for setting notifications sounds;

FIG. 21 is a diagrammatic view of a display enabling setting of Alarm, Chat and Report functions;

FIG. 22 is a diagrammatic view similar to FIG. 20 of a display for customizing Alarm notifications; and

FIG. 23 is a diagrammatic view of a display enabling tailoring of alarm attributes that are displayed.

### DESCRIPTION OF PREFERRED EMBODIMENTS

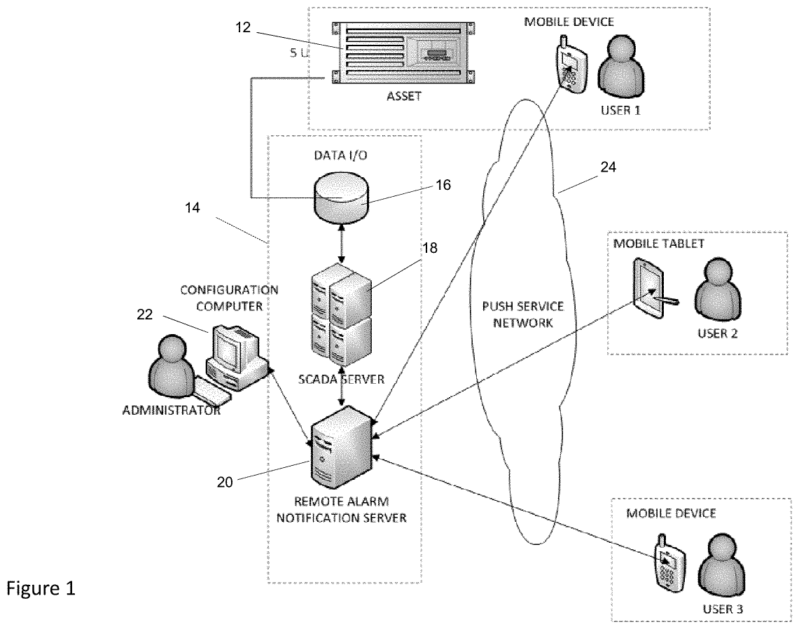

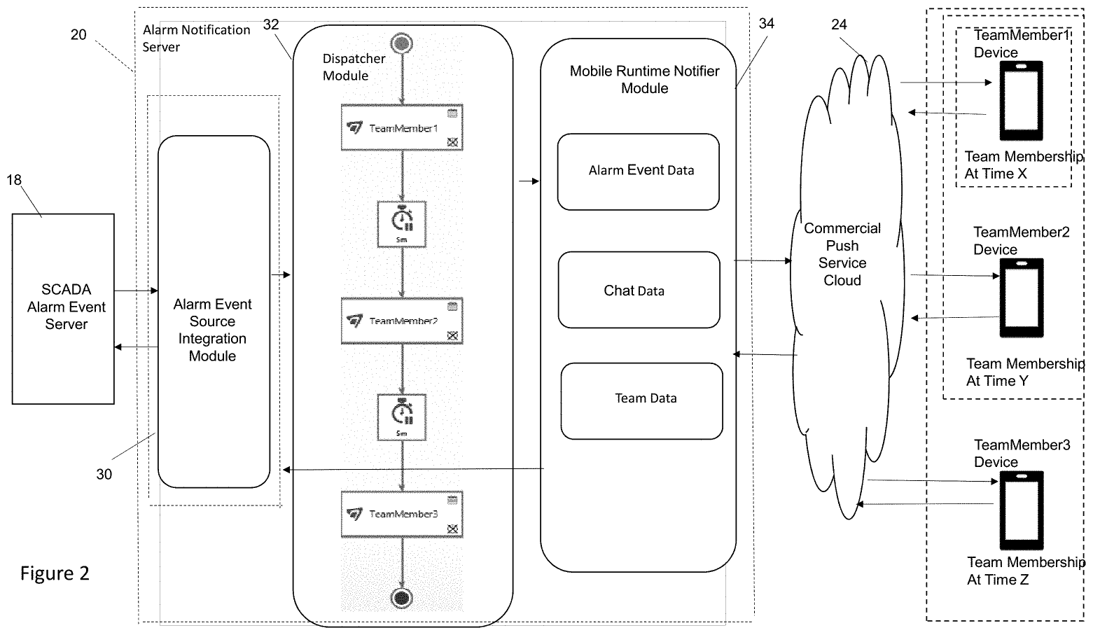

As will be described, the invention comprises an alarm notification system comprising a mobile software application (henceforth referred to as a “Mobile Connection”), as shown in FIGS. 1 and 2, that dynamically creates upon the occurrence of an Alarm event in a monitored system a communications channel for a specific Alarm Lifetime and for specific individual responders (Team Members) associated with that Alarm Lifetime. The communications channel provides status information about the alarm event and responders, and coordinates responses by responding Team Members to enable resolution of the problem which caused the alarm event. The invention affords notifications and details about alarm events for assets of the monitored system as detected by a Supervisory Control and Data Acquisition (SCADA) system and automatically and dynamically forwards notifications and information to the remote mobile devices of appropriate Team Members who are charged with responding to an alarm event during an Alarm Lifetime. The invention enables the Team Members to communicate and coordinate their actions with other Team Members to handle and resolve the cause of the alarm, and advantageously enables alarms to be handled when designated Team Members may be unavailable or during off-hours where a facility may not be fully manned.

As used herein, the term Alarm Lifetime refers to a series of events that begins when a process variable or an asset status of a monitored system enters an alarm condition, and ends upon the acknowledgement of the alarm by a responder and the return of the asset status condition to a normal state. The term Team Members refers to a group of individual alarm responders that are assigned to a specific alarm lifetime. Team membership may be assigned dynamically based on a variety of different factors, such as, e.g., the individual data point of the alarming asset, the nature and type of the alarm, predetermined escalation logic, and an alarm responder's availability or duty schedule.

FIG. 1 illustrates an alarm notification system in accordance with the invention. As shown, the monitored system may include a plurality of assets 12 (only one being shown in the figure), and a Data I/O component 14 which monitors the monitored system's assets. The Data I/O component may include a database 16, a SCADA Server 18, and a Remote Alarm Notification Server 20 comprising a processor and non-transitory memory embodying executable instructions for controlling the processor to perform operations described herein. The Remote Alarm Notification Server 20 receives alarm notifications and data from the SCADA Server 18 that characterize alarm events and issues (pushes) alarm notifications to responsible Team Members according to predetermined factors such as the nature of the alarm and other factors to be described. A Configuration Computer 22 for an Administrator may be connected to the Remote Alarm Notification Server 20 for establishing response protocols based upon the nature and type of an alarm event, and availability and schedules of responders, for assigning Team Members and priorities for responding to alarm events detected by the SCADA Server 18. The Remote Alarm Notification Server 20 may connect via a push service network 24, such as a commercially available cloud, to the mobile devices of Team Members such as User 1, User 2 and User 3 to push notifications and information to the Team Members. User 1 may be on-site of the monitored system or otherwise in the proximity of the asset that produced the alarm event, and Users 2 and 3 may be offsite and remote. The mobile devices of users may be any wireless device, such as a smart phone, a laptop computer, a tablet, etc., comprising processors, memory and executable applications that are capable of supporting the Alarm Event, Chat and Team functions described herein and communicating with the Remote Alarm Notification Server 20.

The mobile devices of users also comprise processors and embody executable applications in their memories that enable communications with the Remote Alarm Notification Server 20 and that enable the users to perform the different functions afforded by the invention to coordinate responses and resolve alarm events, as described herein. In a preferred embodiment, the invention employs a novel approach for responding to alarm events including a set of functions comprising Events, Chat, and Team functions, as will be described. These functions may be activated by tabs on the page display screens of the mobile devices of users as shown in the figures and as described herein.

FIG. 2 is a diagrammatic view that illustrates an overview of the operation and functioning of the alarm event notification system in accordance with the invention. As described in connection with FIG. 1, the alarm event notification system comprises the alarm notification server 20, the SCADA alarm event server 18 that monitors assets of a monitored system, a commercial cloud push service 24, and the mobile computing devices of end user's such as Users 1-3. The SCADA alarm event server comprises the software executable instructions that maintain data, I/O, and that process and forward alarm event indications to the alarm notification server. The alarm notification server 20 may comprise three modules, an alarm event source integration module 30, a dispatcher module 32, and a mobile notification runtime module 34. The alarm event source integration module communicates with the SCADA alarm event server to receive notifications of alarm events and data, processes received alarm events in accordance with predetermined policies, and issues alerts and relays acknowledgements and requests to and from the applications running on the mobile devices of responders.

The dispatcher module 32 comprises the notification and escalation logic functions which match alarm events to predetermined policies and procedures based upon a variety of different factors, such as the nature and criticality of the alarm event, the location of the alarming asset, and responder expertise, availability and notification schedules. This includes receiving the alarm event notification and data from the alarm event source integration module, and invoking an appropriate predetermined notification escalation processing routine to push notifications to appropriate responders via the mobile remote runtime notification module. These policies and procedures may be pre-established routines based upon the type or nature of the alarm event, and may be varied automatically and dynamically based upon actual conditions and Team Member responses. The dispatcher module may send the notification instructions to the mobile runtime notification module.

The mobile runtime notifier module 34 handles notification tasking of users by accepting notification instructions and information (alarm event data, chat data and team data) and pushing notifications to users via the commercial push service cloud 24 such as is available, for example, from Apple and Google. The notifier module may create and maintain the chat operations among users. Team presentation data and logic may receive acknowledgements and chat messages from the end user devices and relay this information to the alarm event source and integration module.

The commercial push cloud service 24 accepts the messages and end user device information and delivers the notifications to the applications on the mobile computing devices of users designated to receive the notifications, and enable the Team Members to view and interact with the SCADA and fellow Team Members, as indicated. The cloud service relays acknowledge requests, chat messages and team updates between the mobile devices and the mobile runtime notifier module.

The figure also illustrates the concept of team development in accordance with an embodiment of the invention. Using the predetermined escalation logic and procedures, after a Team Member 1 receives a first notification at time X, the system may wait a predetermined time period, 5-minutes, for example, for an acknowledgment, during which time the system pauses and waits. Following that time period, at time Y, a second Team Member 2 may be notified by the dispatcher module (whether or not an acknowledgment was received) by being pushed the notification and information about the alarm and acknowledgment, if any. At this point, a team is established comprising the first and second users (Team Members 1 and 2) who may chat, and share alarm event details and team information. After another predetermined time pause, e.g., 5-minutes, a third Team Member 3 may receive a notification at time Z and be added to the team. The third team member can participate in the alarm event response by chatting and reviewing all the team notification details that have occurred since the beginning of the notification, including things that happened prior to the third member being added to the team. The number and particular Team Members notified as part of this escalation logic may vary dynamically based upon the predetermined policy and factors such as whether the notified Team Members have acknowledged their notifications, whether acknowledging Team Members need assistance from others, Team Member requests, etc.

The invention enables Team Members to communicate information and status, and coordinate their responses to alarm events among themselves and with other personnel using the Alarm Event, Chat and Team functions and applications on their mobile devices, as will be described below in connection with the other figures.

Upon receiving a notification of an alarm event from the SCADA Alarm Event Server 18, the server may issue an Alarm Event notification to the Alarm Notification Server 20. This notification may be processed by the Alarm Event Source Integration Module and the Dispatcher Module to select a list of appropriate Team Member responders and an order of priority of notifications to the responders. The Dispatcher Module may cause the Mobile Runtime Notifier Module to forward messages to the Commercial Push Service Cloud which pushes messages to appropriate Team Members. Acknowledgments and the absence of acknowledgments from notified Team Members, as well as any chat messages issued by a Team Member may be returned via the cloud to the Alarm Notification Server, which pushes the chat messages back to the other Team Members. In this way, Team Members as well as administrative and supervisory personnel may be kept advised of status.

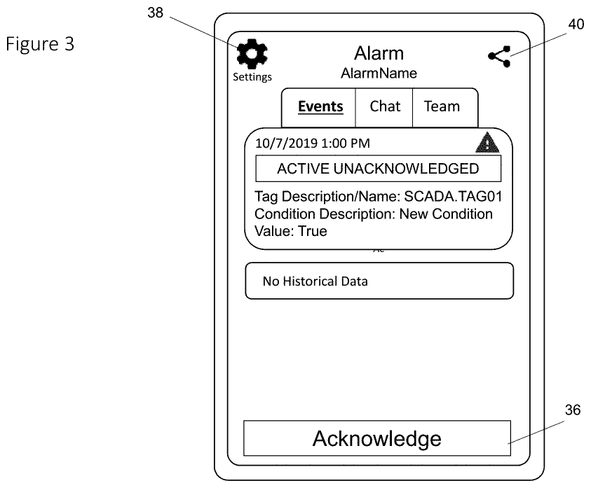

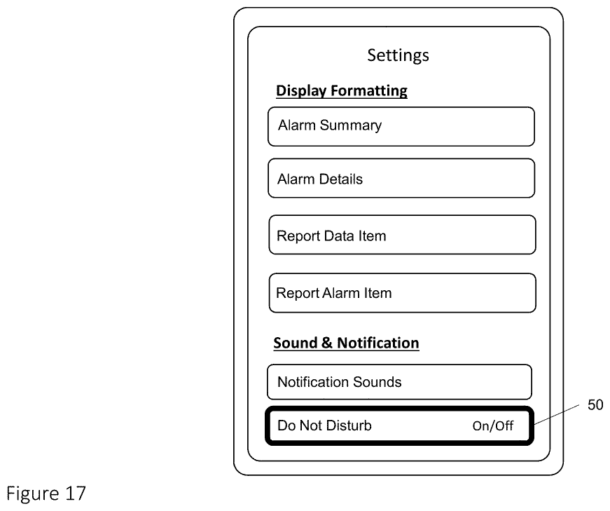

FIG. 3 illustrates an example of an alarm event notification as may be presented on a display screen of the mobile device of a user, such as Team Member 2. As shown, the alarm presentation may include the alarm name, state, description, value, activation time and the display may include an acknowledge button 36 at the bottom of the page. The display may also include a gear cog icon symbol 38 that takes the user to an application settings display such as shown in FIG. 17 where the User can activate a do not disturb (DND) function and customize the alarm presentation format. As shown on the upper right of the display a user may invoke a share icon 40 to send the alarm message to another person, as by utilizing an internet communication application that supports sharing. Also, across the top of the display screen may be the three tabs that toggle between the major functions Events, Chat and Team afforded by the invention and their associated mobile application display screens. Activating any of these tabs may cause the display to transition to the activated screen and dialog. The tabs may persist between all dialog display screens, as shown in the figures, so a user may move seamlessly between display screens as desired.

Activating the Events function tab on a display screen of a mobile device brings up the Events page such as shown in FIG. 3 which displays the details about the alarm, such as its priority, the acknowledgement state, a timestamp, etc.

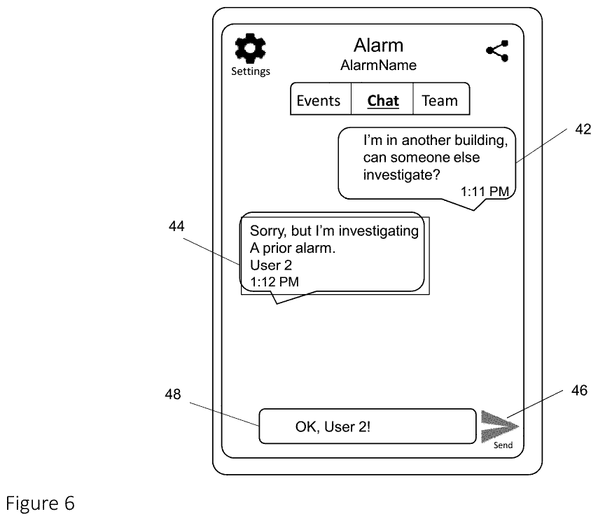

Activating the Chat function tab activates the Chat Display page of FIG. 6 and establishes a channel (or thread) between all Team Members so that the Team Members can communicate in real-time to discuss the actions they have taken and coordinate their responses. This function allows users to communicate with other Team Members during alarm lifetime. Every alarm may be associated with its own channel; thus, all visible communications on a display pertain to a particular alarm and its dedicated Team Members, effectively reducing non-related messages and participants. A group-chat connection is established between each mobile device of a user that has been assigned to the alarm event. All Team Members can access the chat function by selecting the Chat tab, and can see all text entries, as indicated in FIG. 6, for example. In the embodiment shown in FIG. 6, an accessing Team Member's entries are displayed in a right justified chat bubble 42, and other Team Member's comments appear in a left justified chat bubble 44 along with the commenting Team Member's name and a timestamp of the comment. Every alarm lifetime will preferably be associated with a chat channel. Chat messages posted to the channel will result in push notifications being sent to all users (team members) who have been sent the associated alarm. Tapping a push notification, e.g., 46 in FIG. 6, on an application screen will open the application and navigate the user to the corresponding Chat channel. Chat channels will update on the user's device, while they are displayed on the device.

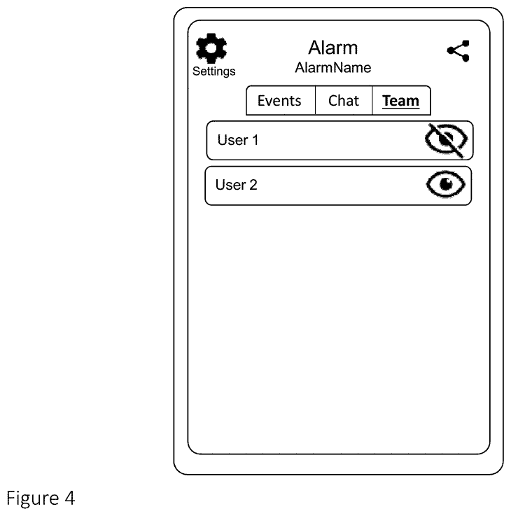

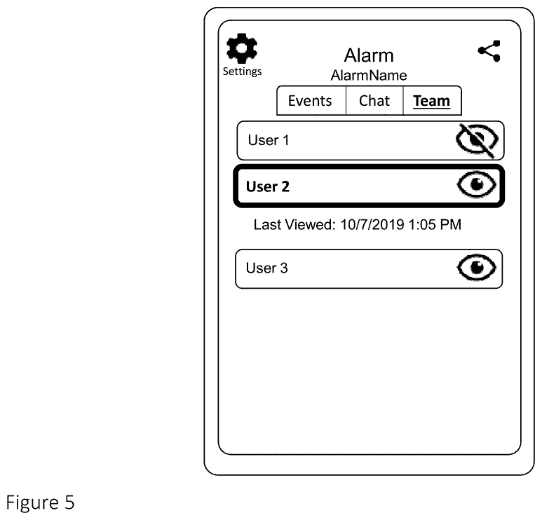

FIG. 5 illustrates an example of a Team display as viewed by User 3. It shows similar information as FIG. 4, but includes User 3's notification. It also shows amplified text information about User 2. Amplified information may be queried by tapping on the User's notification bar as illustrated by a bold user border and text lines that appear beneath the notification bar. The amplified information, as shown in the figure, shows the last time the alarm event was read by User 2.

FIG. 6 illustrates an example of a chat display as viewed by User 3. It indicates a conversation between User 2 and User 3. User 2's chat bubble as well as any other remote responder's chat bubbles appear left justified. User 3's chat bubbles (or whoever the local application user is) appears right justified. At the bottom of the chat display is the text entry field 48 for entering a message and a send button 46 to the right for sending it. The Chat tab is displayed on the Alarm Details screen (FIG. 3) above the alarm information, as well as on other screens. Activating the tab opens the Chat screen enables the Team Member to chat with other Team Members. Chat messages will appear inside a chat bubble on the Chat Display screen. Messages issued by a user may appear in a bubble on the right side of the screen as shown in FIG. 6. A timestamp preferably will be displayed with the message. In some cases, the full date in addition to the time may be displayed. Messages issued by other users may appear in left-justified bubbles of the user's display page along with the body of the message. Other information that may be displayed may include the user name and the associated connection of the user/member who issued the message along with a timestamp. Messages preferably will be ordered chronologically on the page in the order they were issued, with the most recent messages appearing at the bottom of the page. An editable text field 48 is provided at the bottom of the chat display to allow users to enter new messages with a send button 46 to send and close the Chat dialog screen.

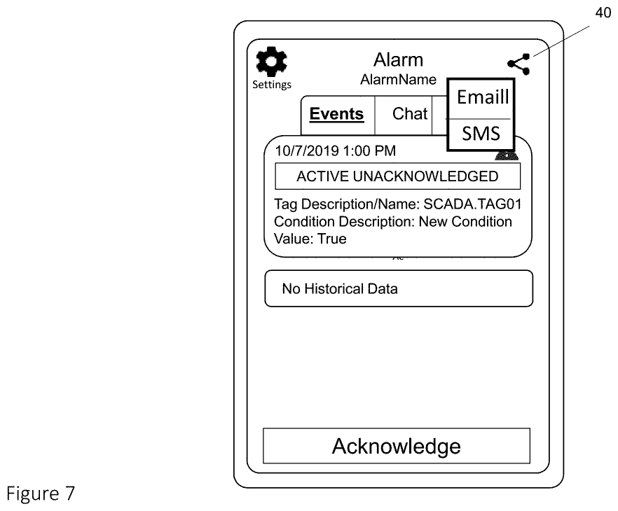

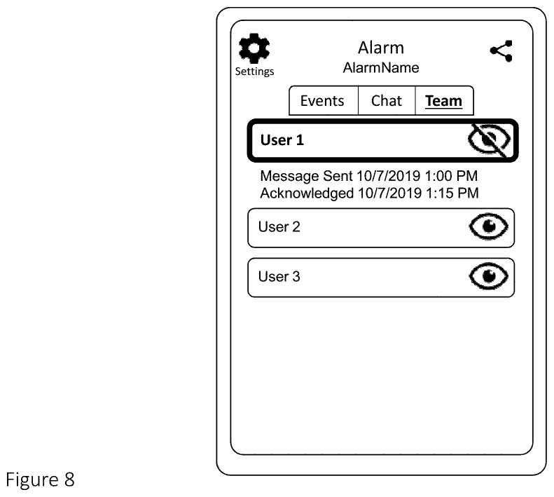

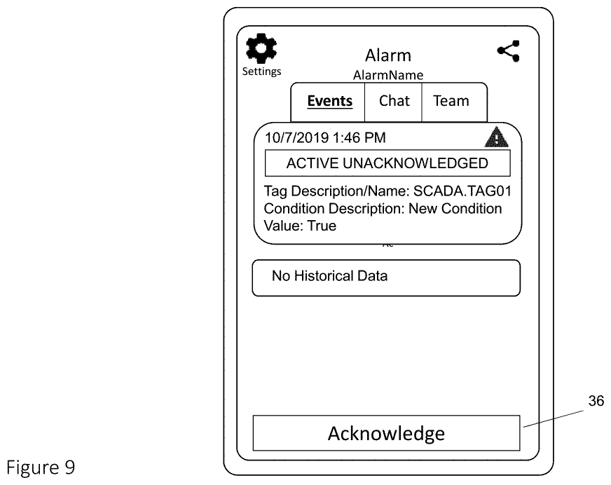

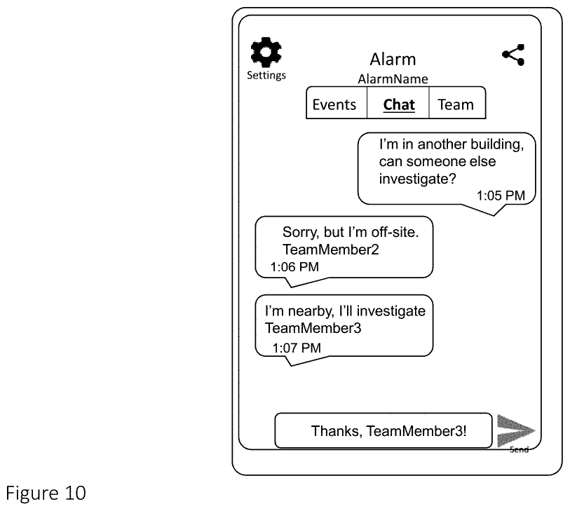

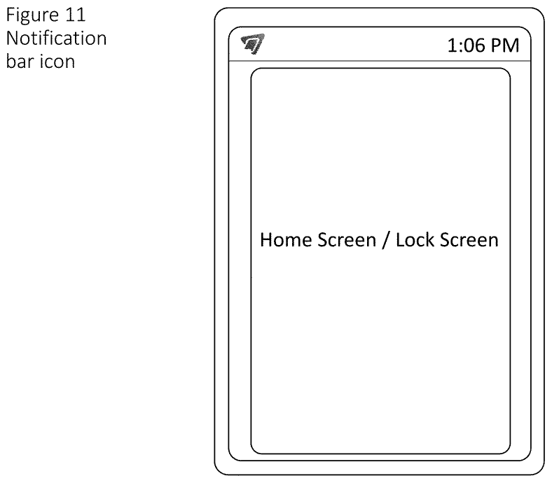

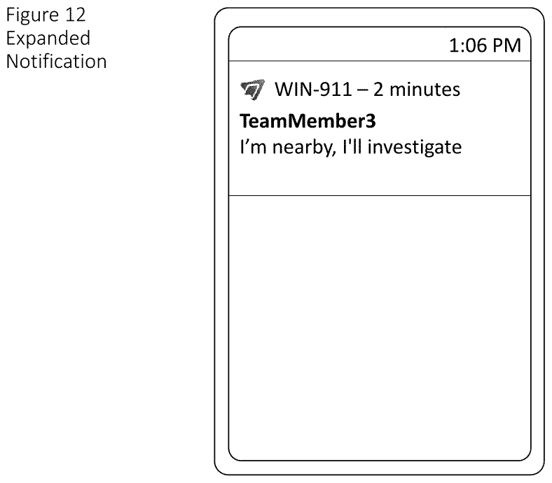

FIGS. 7-8 illustrate an example where a user, e.g., User 3, employs collaboration tools (e.g., email) that are afforded by the invention to attempt to facilitate a response to the alarm condition from others. Using the Team dialog function (FIGS. 4-5), User 3 is able to determine that User 1 is unaware of the alarm (due to the eye icon with a strike-through) and that User 2 is also aware but has elected not to acknowledge the alarm, because of the absence of an acknowledgment status text message below User 2's tab. User 3 may chat with User 2 to find out why, and become aware that User 2 is unavailable. Since User 3 is offsite, he too is unavailable. Thus, he may reach out to User 1 by invoking the share function 40 to send User 1 the alarm message via email to determine if User 1 is able to receive the message via email and respond. FIG. 8 illustrates a Team display as may be viewed by User 3, showing User 1's notification bar amplified by text details. The amplified text details indicate when the message was sent and when User 1 acknowledged the event. User 3 may now be assured that the alarm event is being handled.

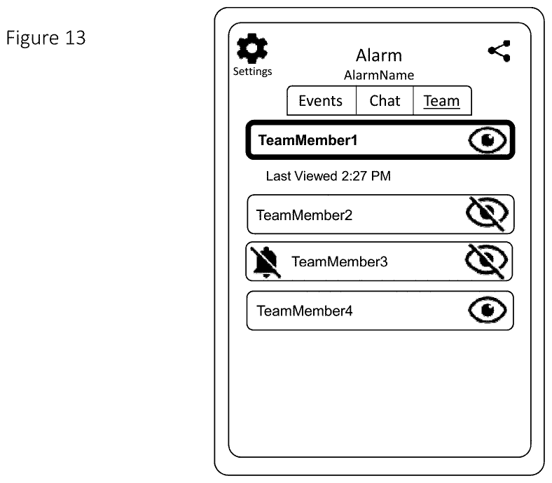

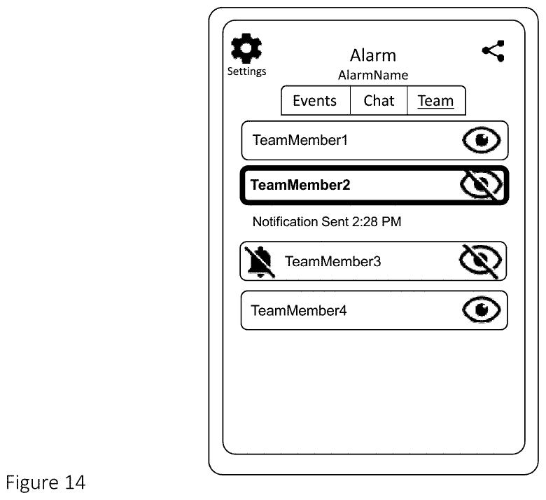

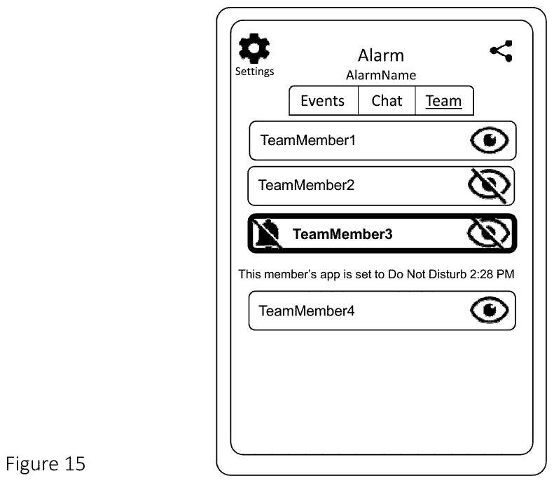

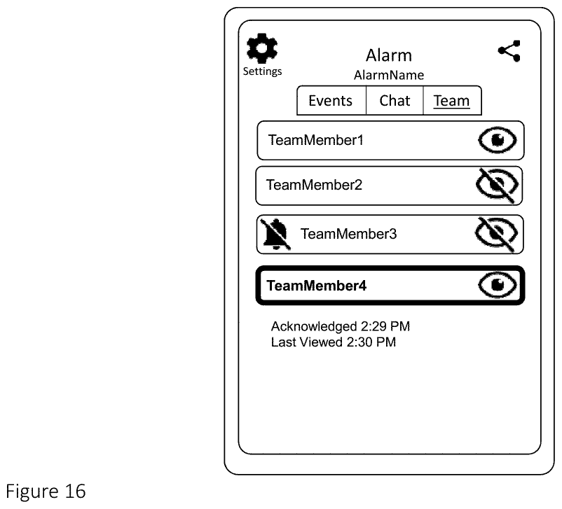

The invention will also include a Team function, as shown for example in FIG. 8, that allows users to see which team members have been informed about events occurring within a specific Alarm Lifetime, and whether or not the individual team members have taken action by acknowledging the alarm. FIGS. 13-16 illustrate several features of a team display. At the top of the Team display, Team Member1 is “focused”. Focusing occurs when the user taps a notification bar. The tapped notification bar may be bolded and amplified text may appear beneath the notification bar. Only one notification bar can be “focused” at a time. In FIG. 13, Team Member1's notification bar is focused. In FIG. 14, Team Member2's notification bar is focused at the expense of “un-focusing” Team Member1's. The figures further illustrate the types of status information focusing may display. Team Member2, for example, was sent a notification, as indicated by the “Notification Sent . . . ” text line below his notification bar, but has not opened his application to read it, as indicated in FIG. 14 by the eye icon with a strike-through.

The notification bar contains the user name (on the left) and a status icon (an “eye”) on the right. If the eye appears open, this indicates that the associated user opened his application after receiving a push notification. If the eye has a strike-through it, as shown in FIGS. 13-16, this indicates that the associated user has not opened the application after receiving the notification. If the application was opened at the time of the notification, status is determined by by whether the alarm has been selected in the alarm summary which takes the user to the alarm events, chat, team dialog. Lastly, there may be a do not disturb icon (e.g., a bell with strike-through) on the left of Team Member3's tab, indicating that the Team Member3 had the DND function activated at the time the notification was sent.

Activating the Team tab brings up the Team Activity display screen of FIGS. 4-5 which provide a list of notification events, such as who was sent a message, whether the message was successfully delivered, and whether or not the message was read. The notification event summary is a summary of events that list attempts to push notifications to team members; indicate whether the push attempt was successful; identify the name of the notified team member; indicate when or if the member downloaded the message; and show if the member acknowledged the alarm. All team members can access this summary by selecting the Team tab on a display screen. The Team tab will preferably also be available across all tabs of the alarm detail screens.

Tapping the Team tab will launch a Team dialog screen, such as shown in FIGS. 14-16. The dialog screen preferably will be scrollable vertically to accommodate a large list of team members, and will preferably display the name and delivery status for each connection for which a notification has been attempted for an alarm. An icon representing the most recent delivery status for each mobile connection may be displayed to the right. Status information may be indicated below a user's tab as text such as:
Alarm push attempted=Company (Alarm Notification Server) used the corresponding device's push service to attempt to send the alarm;
Alarm push successful=Google or Apple informed Company's cloud server that the alarm push was successful;
Alarm push failed=Google or Apple informed Company's cloud server that the alarm push failed;
Alarm received=The team member downloaded the alarm information from his Mobile module;
Alarm acknowledged=The user successfully acknowledged the alarm.

The name of each user's mobile connection may be displayed to the left. Long names may be truncated to fit the display screen. An icon (e.g., a bell with a slash) representing the un-availability (“Do Not Disturb”) status of a user may be displayed to the left of the user's name, as shown for example in FIGS. 13-16.

Information provided by the tools afforded by the invention gives the users an advantage over currently available methods as they consider their response to the alarm event. The result is a better-informed team with enhanced coordination and supervision capabilities, as well as team member accountability.

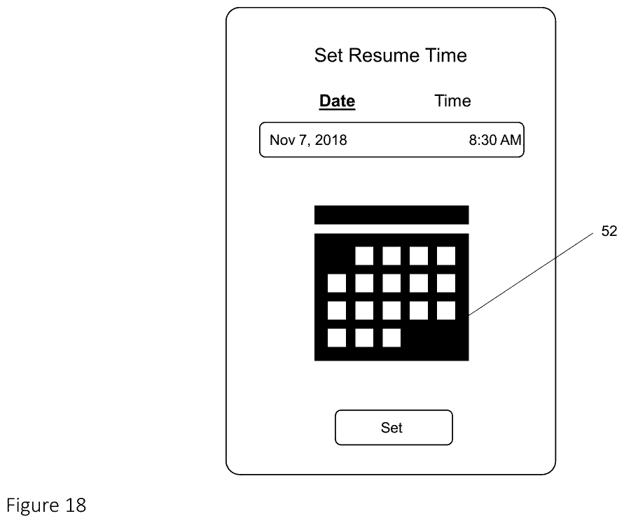

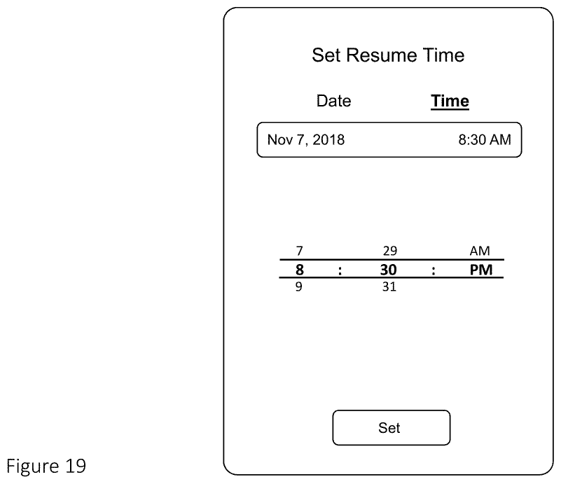

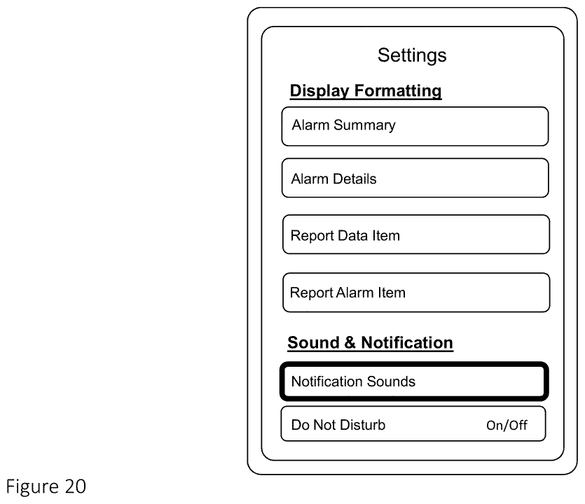

The Do Not Disturb function afforded by the invention enables a team member to be removed from a preset alarm notification delivery list for a span of time specified by the member, as shown in FIGS. 18-19. Thus, team members can have critical user availability information in real-time to enable each member to make an informed decision during each step of the alarm lifetime. This DND function allows users to temporarily opt out of alerts while still allowing access to alarm system information and other features of the invention. This mode of operation will automatically reset at a user specified date and time (specified upon enabling) and is visible to other team members, making it a better option than users simply turning off alerts on their mobile device. In addition, this mode of operation can be canceled and reset at any time by the device user.

The general settings display screen of FIG. 17 allows a user to specify formatting and notification of general settings, as indicated. This settings display may be accessed from the other display pages of by the settings icon 38. FIG. 17 illustrates an example of a general settings workspace to which a user can navigate by tapping the setting (gear cog) icon 38 from any workspace screen display. The general settings display has a series of tabs which the user can select to perform different actions, including setting the do not disturb function which can be “On/Off” toggle as shown. If the DND function is not set, then tapping on the bubble will take the user to a “Set Resume Time and Date” selector, as depicted in the next two FIGS. 18 and 19. The user may manually cancel a DND session by returning to the general setting page and tapping the On/Off toggle 50.

FIG. 18 illustrates an example of a screen display to set a date and time when a DND session will end and return the user to an active user state. The first tab shown on the “Set Resume Time” screen is the date selector as indicated by the bolded and underlined Date tab, and as indicated by the calendar date selector icon 52. The current date may be selected by default, but the user may choose a later date using the calendar icon. The next step is selecting the resume time to end the DND function is to select the actual time of day that the Do Not Disturb session will end. As shown in FIG. 19, there are three parameters to set, i.e., the hour, the minute, and whether the time referenced is AM or PM. Once the desired resume date and time have been selected, the Set button at the bottom of the screens begins the DND session which continues to the set day and time. The Set button may also close the date and time selector screens.

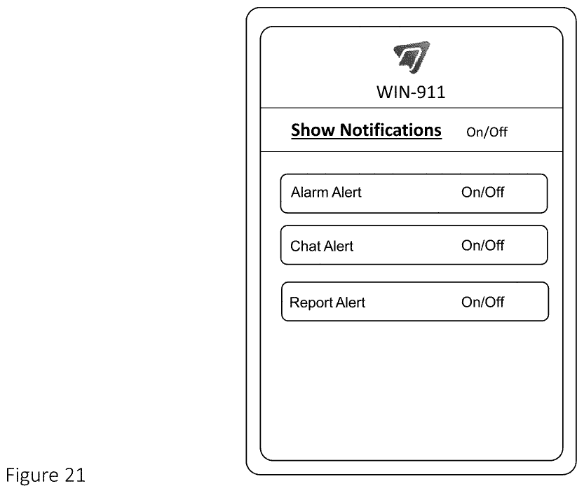

As shown in FIG. 21, mobile notifications may be customized by disabling notifications altogether, or by disabling certain types of notifications, like Alarm Alert, Chat Alert, and Report Alert. Each notification type may be toggled on or off by using the On/Off switches shown.

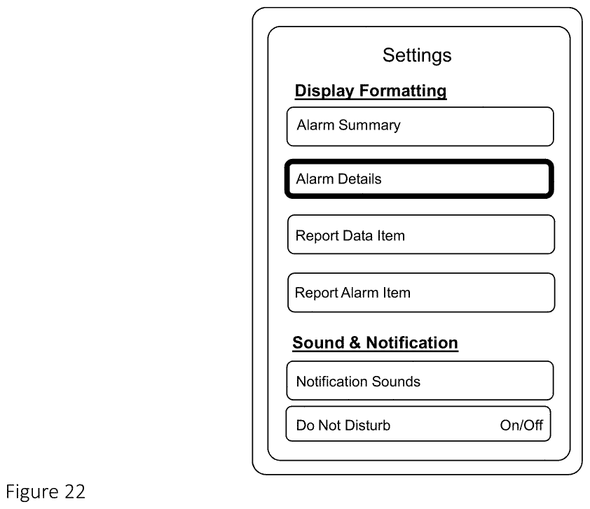

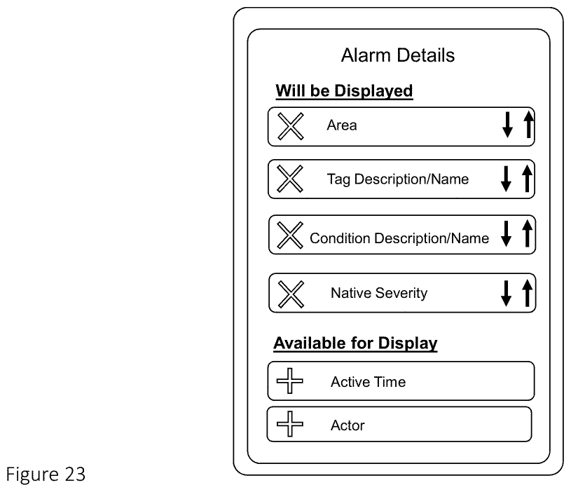

As shown in FIG. 22, from the settings display a user can customize the details of the alarm events display, such as customizing an alarm summary display, and a report summary and details display. If the user taps on the Alarm Details tab (as shown highlighted in bold in the figure) the user may be taken to a menu of alarm attributes (shown in FIG. 23) that enable alarms to be displayed or not from the user's display based on the user's role.

FIG. 23 illustrates an example of the alarm details menu that allows a user to tailor his alarm event display by selecting attributes that can be included or excluded from the display. Alarm events contain a wide variety of information. Some information may more useful to some users than others depending upon their roles. For example, a supervisor responsible for multiple locations may choose to include a location descriptor, while a technician may include process variable information that is not relevant to a maintenance worker. The “Will be Displayed” section of the menu shows attributes that may be included and the order in which they appear on the display. The display of attributes can be reordered by tapping the up or down arrows to the right of each attribute. The attributes can be removed from the display by tapping the “X” icon adjacent to each attribute. Beneath the active attributes list is an “Available for Display” menu which contains attributes that are not currently displayed but can be added by tapping the plus icon adjacent to the attribute.

Attributes that may be controlled may include, for instance, Active Time, Actor, Condition, Description, Condition Name, Gateway Name, Native Severity, Severity, Tag Description/Name, Tag Name and Value, among others. The function or condition represented by each attribute may correspond to the displayed name of the attribute.

The following example of the Alarm Notification process will be helpful in understanding the invention. Referring to FIGS. 1-2, three users, User 1, User 2, and User 3 work for a Company that has deployed systems and methods in accordance with the invention to facilitate user/team member coordination in responding to an alarm event. The three users each have their own mobile computing device, which could take the form of a smartphone or tablet, as mentioned. An Administrator, who also works for the Company, has set up a policy that defines an alarm event notification schedule for remotely located users who are tasked with responding to the alarm event. The schedule may for example, notify User 1, pause for a predetermined period of time, e.g., 5 minutes, in order to allow for User 1 to respond, and in the event that no response is received, then notify User 2. The schedule may again pause for an additional period of time, e.g., five minutes, waiting for a response from User 2, and then notify User 3. The alarm event is considered resolved when one of the Users acknowledges the alarm.

Assume that the asset-related alarm, in this example, is associated with asset 12 (FIG. 1) located near User 1. When the asset-related alarm event occurs, it results in the activation of the notification schedule, and User 1 is immediately pushed a message. However, if User 1's mobile computing device is off-line, he will not receive the message. After five minutes User 2 may be pushed a message but User 2 may be unable to respond due to a prior alarm event in another location, so he declines to acknowledge the alarm. Five more minutes elapse and User 3 is pushed a notification. User 3 may be further away from the asset and wants to check the status of the previously notified users. So, User 3 opens his Team Summary screen (FIG. 4) and immediately sees that User 1 was not able to receive the message, and that User 2 has seen the message. So, User 3 opens the group Chat function (FIG. 6), and asks User 2 why he has not acknowledged the alarm yet. User 2 may respond that he is currently unavailable to respond, and request that User 3 contact another member of the team. User 3 is offsite so he is unable to investigate in a timely fashion. He can safely assume that User 1 is unaware of the alarm so User 3 calls and informs User 1 of the alarm condition. User 1 may now respond by acknowledging the alarm and resolving the situation in a timely and efficient manner. In the event that User 1 does not respond, User 3 may escalate the problem to other personnel.

From the foregoing, it may be seen that that the invention affords a timely and efficient method for automatically and dynamically issuing notifications of alarm conditions to responders who may be local or remote, and for coordinating responses to the alarm condition using the Chat function.

While the foregoing has been with reference to particular embodiments of the invention, it will be appreciated that changes to these embodiments may be made without departing from the principles of the invention as set forth in the appended claims.

1. A method for coordinating responses from responders in a mobile computing environment to an alarm in a monitored system, comprising:
selecting, based upon information identifying the nature and type of an alarm concerning an alarming asset in said monitored system, and based upon predetermined criteria, a team of designated responders that are appropriate for responding to the alarm;
pushing via a cloud an alarm event notification to a mobile device of a first team member of said selected team of designated responders, said alarm event notification comprising said alarm information and a request that said first team member handle a cause of said alarm;
determining whether the first team member acknowledged the alarm event notification, and pushing via said cloud said alarm event notification and said information to a mobile device of a second team member;
establishing a chat communications channel between the first and second team members for the exchange of chat messages; and
coordinating actions between said first and second team members by displaying on said mobile devices of said first and second team members status information for each of said team members and by displaying said chat messages.

2. The method of claim 1, wherein said selecting further comprises selecting team members based upon the nature and type of said alarm, and comprises selecting team members in a priority order based upon each team member's role, availability and proximity to said alarming asset.

3. The method of claim 1 further comprising automatically adding a new team member to said team to replace a non-acknowledging team member.

4. The method of claim 1 further comprising displaying by an application in the mobile device of each team member said information identifying the nature and type of alarm event and the status of acknowledgments of notifications by said team members, and enabling said team member to acknowledge an alarm notification.

5. The method of claim 4 further comprising enabling said team member to send a chat message to a non-responding team member via email.

6. The method of claim 1 further comprising displaying on the mobile device of each team member all chat messages sent and received by said each team member concerning said alarm event during an alarm lifetime, and enabling the team member to enter and send a chat message to the other team members.

7. The method of claim 6 further comprising displaying a timestamp with each displayed message.

8. The method of claim 1 further comprising providing a team application on the mobile device of each team member that is formed to display a notification indication and the acknowledgment status of each said team member.

9. The method of claim 1 further comprising providing in a mobile device of each team members executable instructions formed to enable setting a do not disturb status for said team member for a selectable period of time.

10. The method of claim 1 further comprising providing executable instructions on said mobile device of each team members formed to enable said team member to select attributes and formats for display and to customize notification sounds.

11. The method of claim 1 further comprising storing all alarm event notifications and information and team member responses on a server.

12. Non-transitory computer readable storage media embodying executable instructions for controlling a processor to perform a method for coordinating responses to an alarm from an asset in a monitored system from responders in a mobile computing environment, comprising:
automatically selecting, based upon information identifying the nature and type of an alarm concerning an alarming asset in said monitored system, and based upon predetermined criteria, a team of designated responders that are appropriate for responding to the alarm;
pushing via a cloud an alarm event notification to a mobile device of a first team member of said selected team of designated responders, said alarm event notification comprising said alarm information and a request that said first team member handle a cause of said alarm;
determining whether the first team member acknowledged the alarm event notification, and pushing via said cloud said alarm event notification and said information to a mobile device of a second team member;
establishing a chat communications channel between the first and second team members for the exchange of chat messages; and
coordinating actions between said first and second team members by displaying on said mobile devices of said first and second team members status information for each of said team members and by displaying said chat messages.

13. The non-transitory computer readable storage media of claim 12, wherein said selecting further comprises selecting team members based upon the nature and type of said alarm, and comprises selecting team members in a priority order based upon each team member's role, availability and proximity to said alarming asset.

14. The non-transitory computer readable storage media of claim 12 further comprising instructions for displaying on the mobile device of each team member said information identifying the nature and type of alarm event and the status of acknowledgments of notifications by said team members, and enabling said team member to acknowledge an alarm notification.

15. The non-transitory computer readable storage media of claim 12 further comprising instructions for displaying on the mobile device of each team member all chat messages sent and received by said each team member concerning said alarm event during an alarm lifetime of said alarm event, and enabling the team member to enter and send a chat message to the other team members.

16. The non-transitory computer readable storage media of claim 12, wherein said executable instructions further comprise instructions for displaying a notification indication and the acknowledgment status of each said team member.

17. The non-transitory computer readable storage media of claim 12 further comprising executable instructions on a mobile device of each team members for setting a do not disturb status for said team member for a selectable period of time.

18. The non-transitory computer readable storage media of claim 12 further comprising providing executable instructions on said mobile device of each team members for selecting attributes and formats for display and for customizing notification sounds.

19. A system for coordinating responses from designated responders in a mobile computing environment to an alarm event in a monitored system, comprising:
an alarm notification server formed to receive a notification of said alarm event and information identifying the nature and type of the alarm, the alarm event server adapted to select a team of team members that are appropriate for responding to said alarm;
a dispatch module formed to create alarm notifications and alarm information for said team members in a priority order based upon team member expertise, availability and proximity to an asset of the monitored system that caused the alarm;
a mobile runtime notifier module formed to receive said alarm notifications and alarm information from said dispatcher module and provide said alarm notifications and alarm information to a push cloud service that pushes said alarm notifications and alarm information to said team members; and
executable applications on said mobile devices for receiving and displaying said alarm notifications, and status information of and chat messages between said team members.

20. The system of claim 19, further comprising escalation logic in said alarm notification server for automatically selecting and notifying new team members to replace team members that do not acknowledge said alarm notification.
